(19) United States
(12) Patent Application Publication
(10) Pub. No.: US 2008/0230389 A1
(43) Pub. Date: Sep. 25, 2008

(54) Electrochemical Detector Integrated on Microfabricated Capillary Electrophoresis Chip and Method of Manufacturing the Same

(75) Inventors: Kon Ha, Seoul (KR); Yong Sang Kim, Yongin-si (KR); Chi Jung Kang, Yongin-si (KR); In Je Yi, Pohang-si (KR)

Correspondence Address: THE WEBB LAW FIRM, P.C., 700 KOPPERS BUILDING, 436 SEVENTH AVENUE, PITTSBURGH, PA, 15219, US

(73) Assignee: Myongji University Industry and Academia Cooperation Foundation, Yongin-si (KR)

(21) Appl. No.: 12/053,906

(22) Filed: Mar. 24, 2008

(30) Foreign Application Priority Data
Mar. 22, 2007 (KR) 10-2007-0027990

(51) Int. Cl. G01N 27/00

(52) U.S. Cl. 204/451; 204/601

(57) ABSTRACT

An electrochemical detector integrated on a capillary electrophoresis chip according to the present invention includes: a first substrate having a microchannel; a second substrate adapted to mate with the first substrate and having at least one peripheral electrode for conducting electrophoresis of a sample injected along the microchannel of the first substrate, in which a separation channel is formed along the microchannel by bonding the first substrate with the second substrate; a first electrode, made of indium tin oxide (ITO), formed on the first substrate to be positioned over the separation channel; and a second electrode, made of indium tin oxide (ITO), formed on the second substrate to be positioned under the separation channel, and spaced apart from the first electrode at a predetermined interval, wherein the first electrode and the second electrode constitute a detector to measure electrical characteristics of the sample passing along the separation channel. According to the present invention, since the specific characteristics of a sample can be evaluated by measuring the electrical or genetic characteristics of the sample flowing along the microchannel formed in a chip using a detector, a chip for a micro-analysis system having a simple structure can be realized.

### BACKGROUND OF THE INVENTION

1. Field of the Invention

The present invention relates a detector for detecting the electrical or genetic characteristics of samples, integrated on a microfabricated capillary electrophoresis chip, and a method of manufacturing the same, and, more particularly, to a detector for biochips, which is simply configured and efficiently detects samples, and a method of manufacturing the same.

2. Description of the Related Art

Recently, with the advancement of genetic engineering techniques, biochips, which can be used to diagnose the symptoms of various diseases, have been actively researched. Most commercially available biochips use pure genetic samples obtained through the separation, refinement, genetic amplification and electrophoresis of blood or cells. Currently, research on PCR (polymerase chain reaction) chips and electrophoresis chips, each of which include flow channels and reaction channels formed on a silicon, glass or polymer substrate using MEMS (microelectromechanical systems), is being actively conducted. Methods of detecting desired pure genes using PCR chips or electrophoresis chips include a fluorescence detection method, a UV/Vis spectrophotometric method, an electrochemical method, and the like. However, these methods have many problems in that large-scaled and high-priced equipment is required and it is difficult to fabricate devices in the form of chips because they are complicated. For instance, the optical detection methods, such as the fluorescence detection method and the UV/Vis spectrophotometric method, are problematic in that various optical parts, such as a microbalance, a microfilter, etc., as well as a laser source and a microscope, are required. Further, the electrochemical method is problematic in that electrodes having complicated structures are used, and detection conditions are not suitable for PCR products.

As a first conventional technology, U.S. Pat. No. 6,045,676 discloses an electrochemical detector integrated on a microfabricated capillary electrophoresis chip, in which the change in DNA is detected by providing electrodes in an array type hybridization chamber, fixing probe DNA on the electrodes, and then measuring the change in dielectric constant or dielectric loss from before the probe DNA reacts with target DNA to thereafter. However, the first conventional technology is problematic in that, although it is only observed that DNA itself which is fixed on the electrodes in the hybridization chamber for the purpose of the diagnosis of disease, is changed from single-strand DNA to double-strand DNA, DNA floating and moving in fluid in microchannel cannot be detected.

As a second conventional technology, U.S. Pat. No. 6,169,394 discloses an electrical detector for a micro-analysis system, in which whether or not biomolecules exist is determined by measuring the impedance change when samples, such as cells, biomolecules, ions, etc. flow through microchannel by forming electrodes on both side walls of the microchannel and then applying signal voltage to the electrodes. However, the second conventional technology is problematic in that manufacturing processes are very complicated because electrodes are formed on both side walls of the microchannel.

As such, in conventional chips, the detection of DNA, etc. depends on optical methods or electrochemical methods. The optical methods are problematic in that, since various optical parts, such as laser light sources, lenses, filters, mirrors, and the like, are required, high expenses are incurred and a large amount of space is necessary, and thus it is very difficult to integrate the optical parts,

Further, recently, chips provided therein with laser diodes, filters, etc. in a thin film form have been developed. However, since these chips are manufactured at high cost, they are not suitable for disposable chips for micro-analysis systems.

Furthermore, the electrochemical methods are also problematic in that, since three or more electrodes are required and the material properties of each of the electrodes must vary depending on the purpose in these methods, manufacturing processes are complicated, and particularly, when these methods are conducted using an oxidation-reduction reaction, measurement errors occur due to environmental factors.

### SUMMARY OF THE INVENTION

Accordingly, the present invention has been made keeping in mind the above problems occurring in the prior art.

A first aspect of the present invention provides an electrochemical detector integrated on a capillary electrophoresis chip, including: a first substrate having a microchannel; a second substrate adapted to mate with the first substrate and having at least one peripheral electrode for conducting electrophoresis of a sample injected along the microchannel of the first substrate, in which a separation channel is formed along the microchannel by bonding the first substrate with the second substrate; a first electrode, made of indium tin oxide (ITO), formed on the first substrate to be positioned over the separation channel; and a second electrode, made of indium tin oxide (ITO), formed on the second substrate to be positioned under the separation channel, and spaced apart from the first electrode at a predetermined interval, wherein the first electrode and the second electrode constitute a detector to measure electrical characteristics of the sample passing along the separation channel.

The first substrate may be made of polydimethylsiloxane (PDMS), and the second substrate may be made of glass, quartz, or silicon. More preferably, in the first substrate, the portion having the first electrode formed thereon may be made of glass, quartz or silicon, and the remaining portion may be made of polydimethylsiloxane (PDMS).

The electrical characteristics of the sample, moving between the first electrode and the second electrode, may include capacitance, dielectric constant, resonance frequency, and impedance.

A second aspect of the present invention provides a method of manufacturing an electrochemical detector integrated on a capillary electrophoresis chip, including: forming a microchannel on a first substrate made of polydimethylsiloxane (PDMS); forming at least one peripheral electrode used to conduct electrophoresis of a sample injected along the microchannel, and a second electrode, made of indium tin oxide (ITO), used to measure electrical characteristics of the sample moving along the microchannel, on a second substrate; bonding the first substrate with the second substrate to form a separation channel along the microchannel between the first and second substrates; and forming a first electrode, made of indium tin oxide (ITO), on the first substrate to be positioned over the separation channel, wherein electrical characteristics of the sample passing along the separation channel are detected by the first and second electrodes mating with each other.

The second substrate may be made of glass, quartz, or silicon.

In the method, the formation of the microchannel on the first substrate may include: forming a pattern corresponding to the microchannel on a silicon wafer using a photoresist; forming a PDMS layer on the patterned silicon wafer; and removing the patterned silicon wafer.

Further, the formation of the at least one peripheral electrode for electrophoresis and the second electrode on the second substrate may include: forming an ITO layer having a predetermined thickness on a substrate; applying a photoresist on the ITO layer to form a pattern corresponding to the at least one peripheral electrode and the second electrode; and removing the patterned photoresist to form the at least one peripheral electrode and the second electrode.

Further, the bonding the first substrate with the second substrate may be performed using a UV-Ozone cleaner.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a view showing a capillary electrophoresis chip provided with an electrochemical detector according to the present invention;

FIGS. 2A and 2B are views showing the structures of the capillary electrophoresis chips having electrodes formed thereon according to the present invention, respectively;

FIG. 3 is a sectional view showing a separation channel and a detector provided on the capillary electrophoresis chip according to the present invention;

FIGS. 4A to 4D are process views showing a method of forming a microchannel in a first substrate;

FIGS. 5A to 5D are process views showing a method of fabricating a second substrate having a second electrode, serving as a reference electrode; and

FIG. 6 is a schematic sectional view showing an electrophoresis chip completed using the first substrate of FIGS. 4A to 4D and the second substrate of FIGS. 5A to 5D.

### DESCRIPTION OF THE PREFERRED EMBODIMENTS

Hereinafter, preferred embodiments of the present invention will be described in detail with reference to the attached drawings.

Reference now should be made to the drawings, in which the same reference numerals are used throughout the different drawings to designate the same or similar components.

Generally, since nucleic acid, protein, DNS, cells, and the like, constituting all living things, are electrically polar, when voltage is applied to samples including them and then the voltage and frequency thereof are changed, the specific electrical characteristics of the samples can be measured.

In the present invention, the products obtained through PCR (Polymerase Chain Reaction) are analyzed through electrophoresis using such specific electrical characteristics of samples. The principle of electrophoresis is that components included in a sample are separated from each other according to the difference in sizes and characteristics between the components by gelating the sample and then applying voltage thereto.

In the electrophoresis, sample moves through a capillary separation channel. In the present invention, a pair of electrodes is formed at microchannel of the separation channel using indium tin oxide (ITO), and then a specific voltage and frequency are applied to the pair of electrodes, and thus a detector measures the electrical characteristics of the sample.

Hereinafter, an electrochemical detector integrated on a capillary electrophoresis chip according to the present invention will be described in more detail with reference to the accompanying drawings.

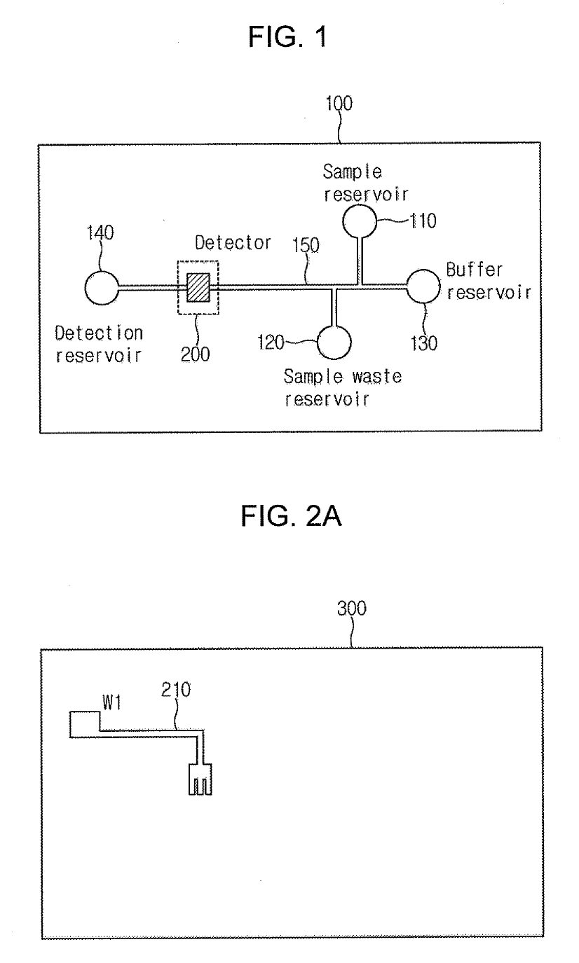

FIG. 1 shows a capillary electrophoresis chip provided with an electrochemical detector according to the present invention.

The capillary electrophoresis chip 100 includes a sample reservoir 110 for storing a sample, a sample waste reservoir 120 for storing sample waste, a buffer reservoir 130 for storing a buffer solution, a separation channel 150 formed of a capillary microchannel, a detector 200 for detecting the electrical characteristics of the sample, and a detected sample reservoir 140 for storing the detected sample.

All solutions introduced into all of the reservoirs are filtered using a membrane filter having a thickness of about 0.45 μm, and all of the microchannel are deionized and then flushed using purified water. Subsequently, all of the reservoirs and the microchannel are filled with buffering solutions, and then the testing sample is loaded in the sample reservoir 110. After the test sample is loaded into the sample reservoir 110, when the sample is injected into the microchannel connected to the sample reservoir 110 by applying an electric field between the sample reservoir 110 and the sample waste reservoir 120, the sample passes through an intersection and flows in the separation channel 150. At this time, the detected sample reservoir 140 is grounded, a separation voltage is applied to the buffer reservoir 130, and other reservoirs are floated. At this time, the sample moves along the separation channel 150, and the detector 200 measures the electrical characteristics of the sample flowing in the separation channel 150.

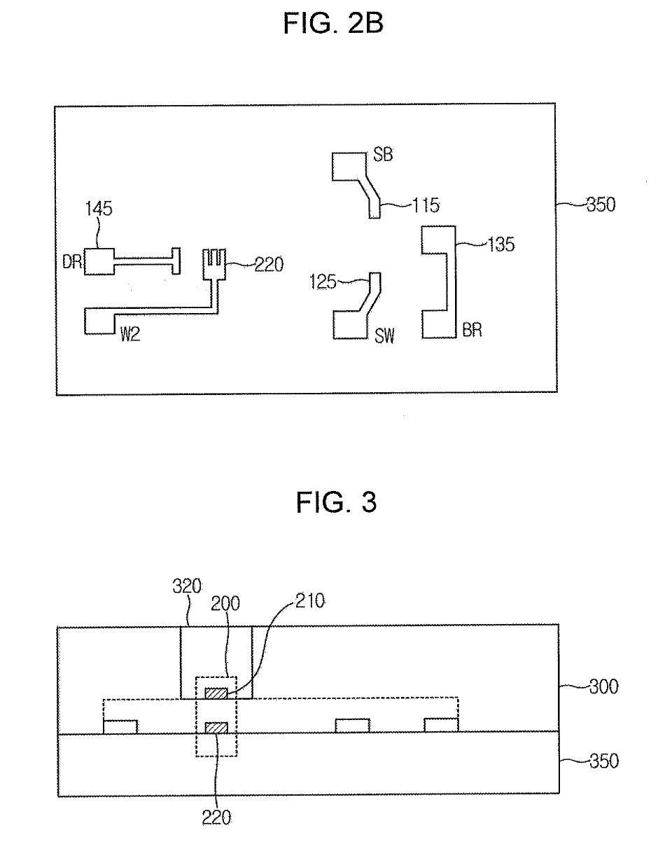

FIGS. 2A and 2B show the structures of the capillary electrophoresis chips having electrodes formed thereon according to the present invention, respectively.

FIG. 2A shows a structure in which a first electrode 210, serving as a working electrode of a detector 200, is formed on a first substrate 300, and FIG. 2B shows a structure in which various electrodes, including a second electrode 220, serving as a reference electrode, an SB electrode 115, an SW electrode 125, a BR electrode 135 and a DR electrode 145, which are used in electrophoresis, are formed on a second substrate 350.

The SB electrode 115 and the SW electrode 125 are electrodes formed to inject a sample, and serve to move a sample to a detector 200 by applying a separation voltage on the BR electrode 135 and the DR electrode 145, thus causing electrophoresis along a separation channel 150.

The detector 200 includes a first electrode 210 formed on a first substrate 300 and a second electrode 220 formed on a second substrate 350, and measures the electrical characteristics of the sample flowing along the separation channel, indicated by dot lines in the drawings, through the first electrode 210 and the second electrode 220. In the case where the detector 200 is a three-electrode system, the detector 200 may further include a counter electrode (not shown) on the second substrate 350.

Generally, electrodes formed on a chip are composed of gold (Au) or platinum (Pt), thus increasing the cost of manufacturing the chip. However, in the present invention, since they are composed of indium tin oxide (ITO), the disposable chips can be manufactured at low cost. Further, in the present invention, the specific characteristic of the sample can be easily and simply evaluated by applying a specific voltage and frequency to the sample flowing in the separation channel through a pair of electrodes, that is, the first electrode and the second electrode, formed on and beneath the chip, thus measuring the electrical characteristics of the sample.

Furthermore, as described below, in the detector 200 according to the present invention, since high voltage for electrophoresis extends in a direction toward the separation channel 150, it is preferred that the detector 200 be configured such that the first electrode 210 and the second electrode 220 are disposed in a direction leading toward the capillary tubes of the separation channel, so that the direction of the measured voltage is perpendicular to the direction of the electric field in electrophoresis. When the detector 200 is configured in this way, the occurrence of noise due to the voltage in electrophoresis is minimized, thus decreasing measurement errors attributable to changes in the external environment.

FIG. 3 shows a separation channel and a detector provided on the capillary electrophoresis chip according to the present invention.

The detector 200 includes a first electrode 210 formed on a first substrate 300 and a second electrode 220 formed on a second substrate 350, and the first electrode 210 and second electrode 220 are symmetrically arranged and spaced apart from each other.

As shown in FIG. 3, a microchannel is formed on the first substrate 300, and a separation channel 150 is formed along the microchannel by bonding the first electrode 210 and the second electrode 220.

The first substrate 300 is chiefly composed of polydimethylsiloxane (PDMS), but the portion thereof on which the first electrode 210 is formed may be composed of glass, quartz, or the like in order to form the first electrode 210 of the detector 200.

The second substrate 350 is provided thereon with the second electrode 220 and electrodes for electrophoresis. The sample moves along the separation channel 150 due to the electrophoresis conducted using the electrodes for electrophoresis, and the specific characteristics of the sample are measured by the first electrode 210 and the second electrode 220, formed in the separation channel 150.

Generally, microchips in an ECD system (electrochemical detection system) include a substrate made of glass, quartz, or the like. A microchip including such a glass substrate is difficult to manufacture in a general laboratory because it must be manufactured in a clean room at a high molding temperature. Therefore, in the present invention, the first substrate 300 is fabricated using polydimethylsiloxane (PDMS), which makes it easy to fabricate a delicate first substrate even at low temperatures, and has excellent optical properties and high adhesivity. As such, since a microchannel is formed on the first substrate 300, made of PDMS, a delicate microchannel can be formed much more easily than at the time of forming a separation channel using glass, quartz, or the like, and, when the first substrate 300 and the second substrate 350 are bonded, the separation channel 150 is formed along the microchannel.

Here, when the first substrate 300 and the second substrate 350 are cleaned using a UV-Ozone cleaner before the first substrate 300 and the second substrate 350 are sequentially bonded to the separation channel, the bonding strength between the first substrate 300, made of PDMS, and the second substrate 350, made of glass, etc. can be increased.

When an alternating voltage having a specific frequency is applied between the first electrode 210 and the second electrode 220, an electric field is formed therebetween, and thus charged particles flowing in the separation channel are influenced by the electric field, so as to show specific behavior.

The detector 200 of the present invention detects the specific characteristic of a sample by measuring the electrical characteristics attributable to the specific behavior of the charged particles. The electrical characteristics may vary depending on the media located between the two electrodes. For example, when dipoles or charged particles exist in the insulation medium located between the first electrode 210 and the second electrode 220, there is a tendency to increase capacitance, and thus the specific characteristics of the sample can be detected by measuring the change in the capacitance. Further, the specific characteristics of the sample may be detected by measuring the change in dielectric constant directly related with dipole moment and charge amount or the change in resonance frequency greatly influenced by particle size, particle weight and environmental factors. Furthermore, the specific characteristics of the sample may be detected by measuring the change in impedance or admittance related to resistance occurring when an alternating voltage is applied between the first electrode 210 and the second electrode 220. These measured values also change depending on the ion concentration between the two electrodes, the presence of DNA etc. therebetween, and the distance therebetween.

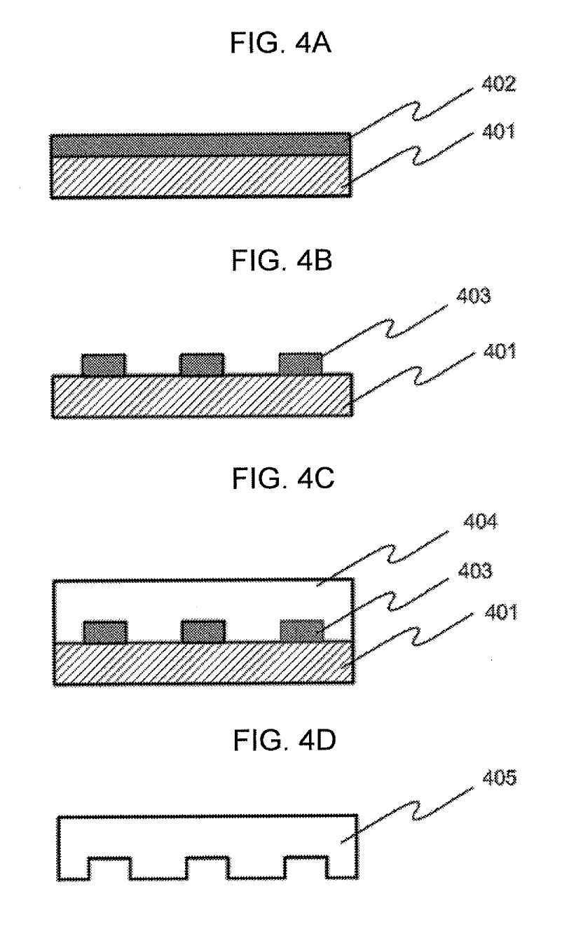

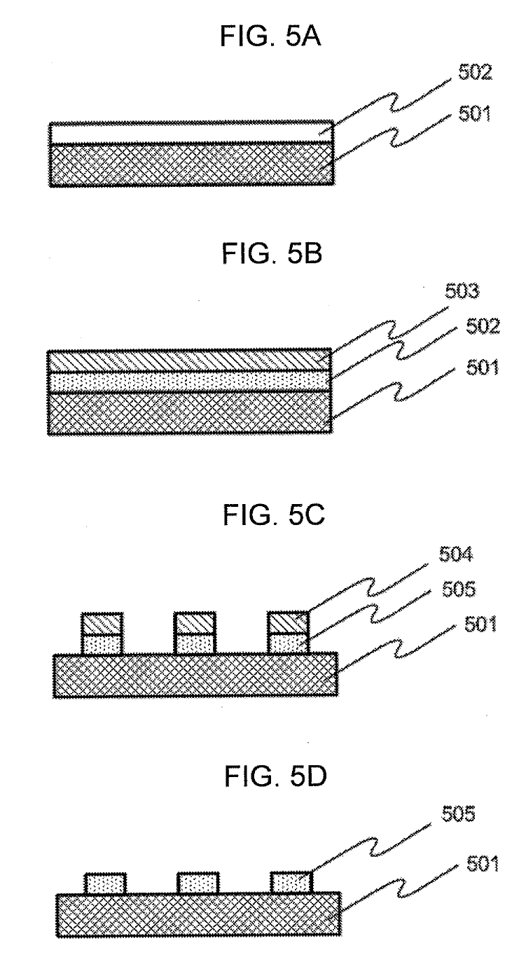

FIGS. 4A to 4D and 5A to 5D show methods of manufacturing a capillary electrophoresis chip according to an embodiment of the present invention.

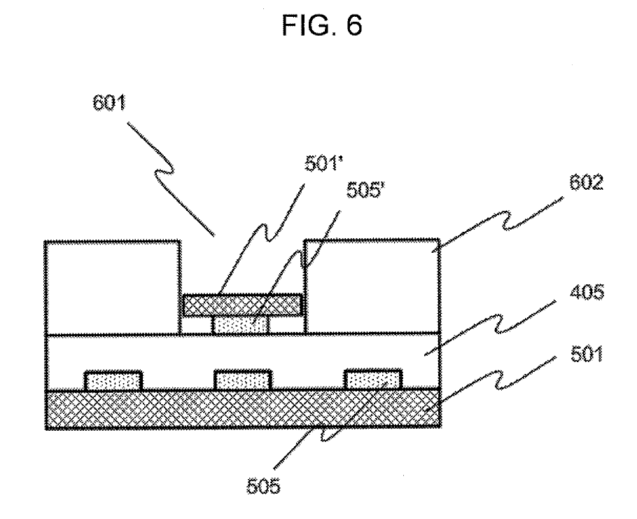

FIGS. 4A to 4D show a method of forming a microchannel in a first substrate, FIGS. 5A to 5D show a method of fabricating a second substrate having a second electrode, etc., serving as a reference electrode, and FIG. 6 is a schematic sectional view showing an electrophoresis chip completed using the first substrate of FIGS. 4A to 4D and the second substrate of FIGS. 5A to 5D.

In order to form a PDMS layer having a microchannel of the first substrate, a photoresist 402, for example, SR-850, is applied on a silicon wafer 401 using a spin coating method, as shown in FIG. 4A, and then a pattern 403 corresponding to the microchannel is formed thereon, as shown in FIG. 4B. In this case, it is preferred that the height of the patterned photoresist be approximately 40 μm, which is the same as the depth of the microchannel in the PDMS layer to be formed later. Subsequently, PDMS is applied on the silicon wafer 401 having the patterned photoresist 403 formed thereon to form a PDMS layer 404, as shown in FIG. 4C, and then the PDMS layer 404 is cured and then separated from the silicon wafer 401 having the patterned photoresist 403 formed thereon to form a PDMS layer 405 having the microchannel formed therein, as shown in FIG. 4D. In this case, the PDMS used in the formation of the PDMS layer may be a mixture in which a silicon elastomer (Sylgard 184) and a curing agent are mixed at a ratio of 10:1, and the PDMS layer 404 formed using this PDMS (Sylgard 184) may be cured at a temperature of about 72□ for about 1 hour.

Meanwhile, a second substrate is fabricated through a process that is different from the process of fabricating the first substrate. First, as shown in FIG. 5A, an ITO layer 502 is formed on a glass substrate 501 through R.F. magnetron sputtering. In this case, the ITO layer 502 may have a thickness of about 340 nm and a surface resistance of 10 ohm/sq. In order to form ITO electrodes 505, as shown in FIGS. 5B and 5C, a photoresist 503, for example, AZ 1512, is applied on the ITO layer 502, patterns corresponding to electrodes to be formed on a second substrate are formed on the glass substrate 501, and then the patterns formed on the glass substrate 501 are etched to form final ITO electrodes 505. In the final ITO electrodes, a reference electrode and a counter electrode may have widths of about 100 μm and 200 μm, respectively.

Further, a work electrode having a width of about 100 μm is formed using the same method as in the fabrication of the second substrate, and is then appropriately cut. Subsequently, as shown in FIG. 6, a glass substrate 501′, having the work electrode formed thereon, and a PDMS layer 602, having an opening 601, are additionally provided, and then the PDMS layer 602 is bonded with the PDMS layer 405 having the microchannel formed therein such that the work electrode faces the reference electrode of the second substrate, and simultaneously the PDMS layer 405 is bonded with the glass substrate 501 having the reference electrode 505 formed thereon using a UV-Ozone cleaner, thereby completing a capillary electrophoresis chip.

As described above, according to the present invention, since the specific characteristics of a sample can be evaluated by measuring the electrical or genetic characteristics of the sample flowing along the microchannel formed in a chip using a detector, a chip for a micro-analysis system having a simple structure can be realized. Further, according to the present invention, since cheap ITO electrodes are used instead of conventional expensive gold (Au) or platinum (Pt) electrodes, manufacturing costs can be decreased.

Further, according to the present invention, since the microchannel is formed in a polydimethylsiloxane (PDMS) substrate and the formed microchannel is used as a separation channel, various desired types of microchannel can be easily formed, manufacturing costs are low, and the integration thereof is easy.

Furthermore, according to the present invention, since the electrical characteristics of a sample are measured by applying a specific voltage and frequency to a pair of electrodes located in a separation channel, the sample is little influenced by environmental factors, and thus accurate measurement values can be obtained.

The electrochemical detector integrated on a capillary electrophoresis chip according to the present invention can be variously modified and applied within the technical scope and spirit of the present invention, and is not limited to the above embodiment. As described above, although the preferred embodiments of the present invention have been disclosed for illustrative purposes, those skilled in the art will appreciate that various modifications, additions and substitutions are possible, without departing from the scope and spirit of the present invention as disclosed in the accompanying claims.

What is claimed is:

1. An electrochemical detector integrated on a capillary electrophoresis chip, comprising:
a first substrate having a microchannel;
a second substrate adapted to mate with the first substrate and having at least one peripheral electrode for conducting electrophoresis of a sample injected along the microchannel of the first substrate, in which a separation channel is formed along the microchannel by bonding the first substrate with the second substrate;
a first electrode, made of indium tin oxide (ITO), formed on the first substrate to be positioned over the separation channel; and
a second electrode, made of indium tin oxide (ITO), formed on the second substrate to be positioned under the separation channel, and spaced apart from the first electrode at a predetermined interval,
wherein the first electrode and the second electrode constitute a detector to measure electrical characteristics of the sample passing along the separation channel

2. The electrochemical detector integrated on a capillary electrophoresis chip according to claim 1, wherein the first substrate is made of polydimethylsiloxane (PDMS), and the second substrate is made of glass, quartz, or silicon.

3. The electrochemical detector integrated on a capillary electrophoresis chip according to claim 1,
wherein, in the first substrate, a portion having the first electrode formed thereon is made of glass, quartz or silicon, and a remaining portion is made of polydimethylsiloxane (PDMS), and
wherein the second substrate is made of glass, quartz, or silicon.

4. The electrochemical detector integrated on a capillary electrophoresis chip according to claim 1, wherein the electrical characteristics of the sample moving between the first electrode and the second electrode, include capacitance, dielectric constant, resonance frequency, and impedance.

5. A method of manufacturing an electrochemical detector integrated on a capillary electrophoresis chip, comprising:
forming a microchannel on a first substrate made of polydimethylsiloxane (PDMS);
forming at least one peripheral electrode used to conduct electrophoresis of a sample injected along the microchannel, and a second electrode, made of indium tin oxide (ITO), used to measure electrical characteristics of the sample moving along the microchannel, on a second substrate;
bonding the first substrate with the second substrate to form a separation channel along the microchannel between the first and second substrates; and
forming a first electrode, made of indium tin oxide (ITO), on the first substrate to be positioned over the separation channel,
wherein electrical characteristics of the sample passing along the separation channel are detected by the first and second electrodes mating with each other.

6. The method of manufacturing an electrochemical detector integrated on a capillary electrophoresis chip according to claim 5, wherein the second substrate is made of glass, quartz, or silicon.

7. The method of manufacturing an electrochemical detector integrated on a capillary electrophoresis chip according to claim 5,
wherein the forming a microchannel on a first substrate comprises:
forming a pattern corresponding to the microchannel on a silicon wafer using a photoresist;
forming a PDMS layer on the patterned silicon wafer; and
removing the patterned silicon wafer.

8. The method of manufacturing an electrochemical detector integrated on a capillary electrophoresis chip according to claim 5,
wherein the forming the at least one peripheral electrode for electrophoresis and the second electrode on the second substrate comprises:
forming an ITO layer having a predetermined thickness on a substrate;
applying a photoresist on the ITO layer to form a pattern corresponding to the at least one peripheral electrode and the second electrode; and
removing the patterned photoresist to form the at least one peripheral electrode and the second electrode.

9. The method of manufacturing an electrochemical detector integrated on a capillary electrophoresis chip according to claim 5, wherein the bonding the first substrate with the second substrate is performed using a UV-Ozone cleaner.
